(19) United States
(12) Patent Application Publication
(10) Pub. No.: US 2006/0053445 A1
(43) Pub. Date: Mar. 9, 2006

(54) Digital broadcast receiver and method of providing program guide using the digital broadcast receiver

(75) Inventor: Seok-chool Choi, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/218,523

(22) Filed: Sep. 6, 2005

(30) Foreign Application Priority Data
Sep. 9, 2004 (KR) 2004-72180

(51) Int. Cl. H04N 5/445; H04N 7/173; G06F 13/00

(52) U.S. Cl. 725/39; 725/100; 725/131

(57) ABSTRACT

Provided are a digital broadcast receiver and a method of providing a program guide, which enable a user to easily watch in real time or time-record a broadcast program of his or her interest. The digital broadcast receiver includes a reading unit which reads program guide information from a data signal contained in a broadcast signal, and a control unit which extracts an item chosen by a user from the read program guide information and outputs the extracted item when a broadcast program that matches the extracted item is broadcasted.

### CROSS-REFERENCE TO RELATED APPLICATION

This application claims the benefit of Korean Patent Application No. 10-2004-0072180 filed on Sep. 9, 2004 in the Korean Intellectual Property Office, the disclosure of which is incorporated herein by reference

### BACKGROUND OF THE INVENTION

1. Field of the Invention

The present invention relates generally to a digital broadcast receiver and a method of providing a program guide using the digital broadcast receiver. More particularly, embodiments of the present invention relate to a digital broadcast receiver which enables a user to conveniently watch in real time or time-record a program of his or her interest and a method of providing a program guide using the digital broadcast receiver.

2. Description of the Related Art

A variety of digital broadcast receivers have been developed and commercialized since the commencement of digital broadcasting. Digital broadcast receivers are provided with an electronic program guide (EPG) regarding broadcast programs according to the Program System Information Protocol (PSIP). An EPG according to the Advanced Television Standard Committee (ATSC)/PSIP standard includes a list of a plurality of broadcast programs and information regarding the start time, the summary of content, and the rating of each of the broadcast programs.

A broadcasting system transmits video and audio signals of a plurality of broadcast programs to be broadcasted at a predetermined period of time and information regarding the broadcast programs. A digital broadcast receiver receives the video and audio signals and the information and then processes and stores the received video and audio signals and the received information. Thereafter, the broadcast program receiving apparatus provides the processed video and audio signals and the processed information to a viewer.

Then, the user can obtain information regarding the title, rating, start time and channel of each of the broadcast programs from the information provided by the digital broadcast receiver and can time-record any of the broadcast programs with reference to the obtained information.

FIG. 1 is a block diagram of a conventional digital broadcast receiver. Referring to FIG. 1, the conventional digital broadcast receiver includes a tuner 10 which receives a broadcast signal, a dividing unit 20 which divides the broadcast signal received by the tuner 10 into a video signal, an audio signal, and a data signal, a video decoding unit 31, which decodes the video signal, an audio decoding unit 32 which decodes the audio signal, a memory unit 40 which stores the data signal, and a control unit 50 which controls a video output unit 61 and an audio output unit 62 to output the video signal and the audio signal, respectively.

When a user requests an EPG, the control unit 50 extracts EPG data from the data signal stored in the memory unit 40 and outputs the extracted EPG data to the video output unit 61 via a graphic user interface. For example, the controller 50 may output an EPG by displaying program information, such as the title of a program corresponding to a cell from a particular channel and time slot displayed by the graphic user interface.

In a case where the video signal is output via the video output unit 61, the control unit 50 overlays the output video signal with the graphic user interface.

A conventional method of providing a program guide using a conventional digital broadcast receiver will now be described. FIG. 2 is a flowchart of a conventional method of providing a program guide using the conventional digital broadcast receiver as illustrated in FIG. 1. Referring to FIGS. 1 and 2, in operation S11, the tuner 10 receives a broadcast signal, and the dividing unit 20 divides a video signal, an audio signal, and a data signal from the broadcast signal received by the tuner 10.

In operation S12, the control unit 50 stores the data signal in the memory unit 40. In operation S13, the control unit 50 determines whether a user has issued a request for a program guide.

In operation S14, if it is determined that the user has issued a request for a program guide in operation S13, the control unit 50 extracts information regarding a program guide from the data signal stored in the memory unit 40. In operation S15, the control unit 50 outputs the extracted program guide information to the video output unit 61 via a predetermined graphic user interface. Then, the user can review information regarding a plurality of broadcast programs to be broadcasted at a predetermined period of time via the graphic user interface and can time-record any of the programs of his or her interest.

Even for a broadcast program that has already been broadcasted, or for a broadcast program that is part of a series of broadcast programs, the user may want to watch it. In such instances, the user needs to identify a start time when the broadcast program of his or her interest will be broadcasted to time-record or watch in real time the broadcast program.

In addition, the user may forget to watch a broadcast program of his or her interest while watching other broadcast programs even though he or she has already identified the start time when the broadcast program of his or her interest will be broadcasted.

Therefore, there is a need for a method for reminding a user of the time when a broadcast program of his or her interest is to be broadcasted, thus enabling the user to easily time-record or watch in real time the broadcast program of his or her interest.

Korean Patent Laid-Open Gazette No. 2001-0069122 discloses a broadcast program time-recording method in which it is possible to enable a user to easily record a broadcast program of his or her interest through reservation by notifying the user of the broadcasting of the broadcast program of his or her interest. However, in this broadcast program time-recording method, the user must select an item for the broadcast program of his or her interest from a time-recording setting window and thus is required to learn how to use the reservation setting window.

### SUMMARY OF THE INVENTION

The present invention provides a digital broadcast receiver, which enables a user to conveniently time-record or watch in real time a broadcast program of his or her interest by providing a program guide to the user without additional manipulation from the user, and a method of providing a program guide using the digital broadcast receiver.

According to an aspect of the present invention, there is provided a digital broadcast receiver including a reading unit which reads program guide information from a data signal contained in a broadcast signal, and a control unit which extracts an item chosen by a user from the read program guide information and outputs the extracted item when a broadcast program that matches the extracted item is broadcasted.

According to another aspect of the present invention, there is provided a method of providing a program guide using a digital broadcast receiver including reading program guide information from a data signal contained in a broadcast signal, extracting an item chosen by a user from the read program guide information, and outputting the extracted item when a broadcast program that matches the extracted item is broadcasted.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional digital broadcast receiver;

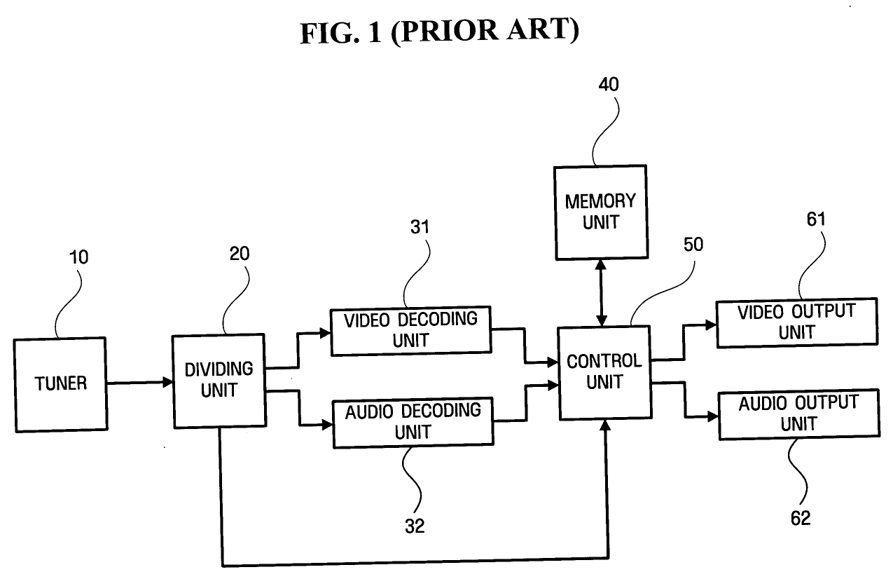

FIG. 2 is a diagram of a method of providing a program guide using the conventional digital broadcast receiver;

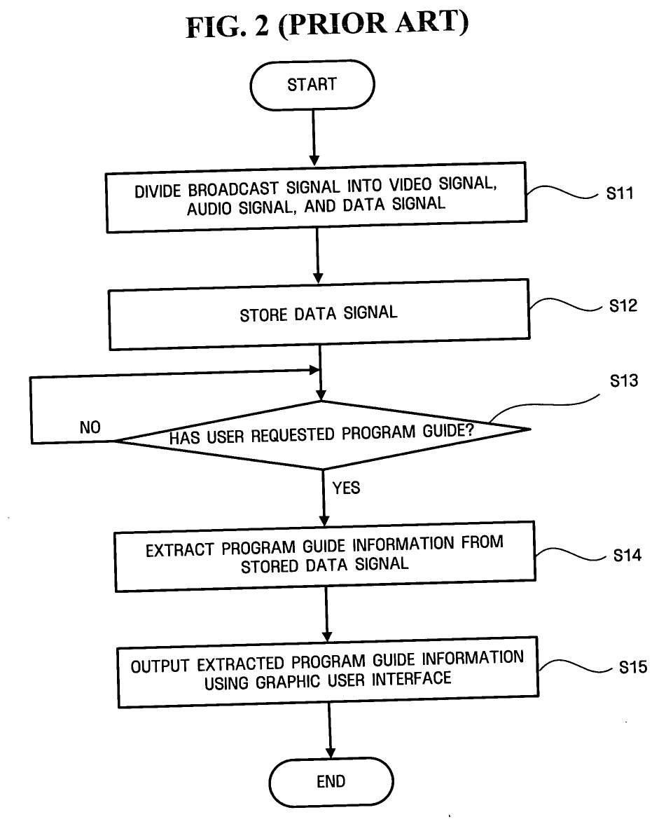

FIG. 3 is a block diagram of a digital broadcast receiver according to an exemplary embodiment of the present invention;

FIG. 4 is a schematic representation of program guide information displayed using a graphic user interface according to an exemplary embodiment of the present invention;

FIG. 5 is a flowchart of a method of providing a program guide using a digital broadcast receiver according to an exemplary embodiment of the present invention;

FIG. 6 is a flowchart of a method of providing a program guide regarding a program of a user's interest using a digital broadcast receiver according to an exemplary embodiment of the present invention; and

FIG. 7 is a schematic representation of a screen on which a program guide for a program of a user's interest is displayed using a digital broadcast receiver according to an exemplary embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

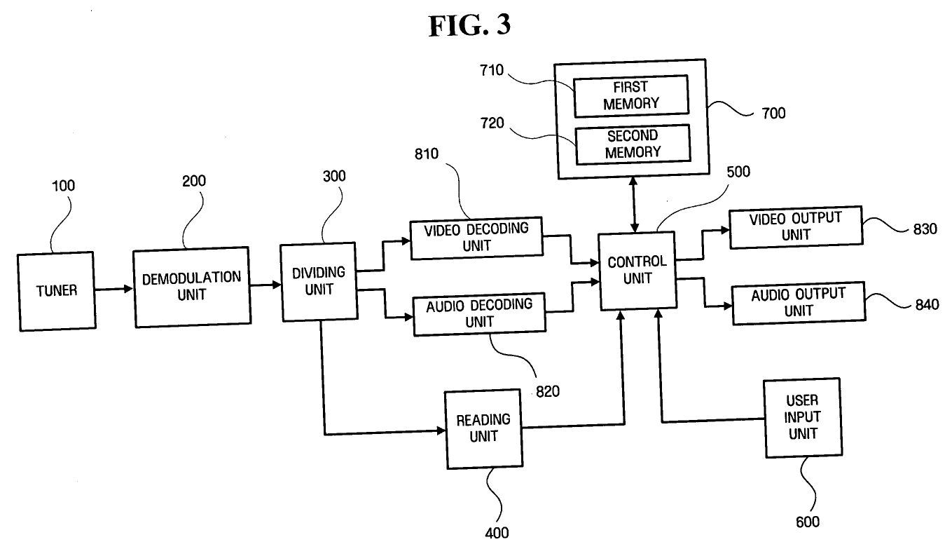

FIG. 3 is a block diagram of a digital broadcast receiver according to an exemplary embodiment of the present invention. Referring to FIG. 3, the digital broadcast receiver includes: a tuner 100 which receives a broadcast signal; a demodulation unit 200 which modulates the received broadcast signal by digitalizing the received broadcast signal and then outputs the modulated broadcast signal as a transport stream; a dividing unit 300 which divides the modulated broadcast signal into a video signal, an audio signal, and a data signal; a reading unit 400 which reads program guide information from the data signal; and a control unit 500 which extracts an item of a user's interest from the read program guide information and outputs the extracted item when a broadcast program that matches the extracted item is broadcasted.

The digital broadcast receiver may also include: a user input unit 600 wherein a value chosen by the user is input; a memory unit 700 which stores the item extracted by the control unit 500; a video decoding unit 810 which decodes the video signal; an audio decoding unit 820 which decodes the audio signal; a video output unit 830 which outputs the decoded video signal; and an audio output unit 840 which outputs the decoded audio signal.

The program guide information included in the data signal may include at least one of program title information, program content summary, start time information, running time information, rating information, genre information, and still shot information. A broadcast station that provides the program guide information may delete or modify any of the items of the program guide information or may add a new item to the program guide information.

The control unit 500 outputs the program guide information read from the data signal by the reading unit 400 via a predetermined graphic user interface. Then, the user can select one of the items of the program guide displayed via the graphic user guide.

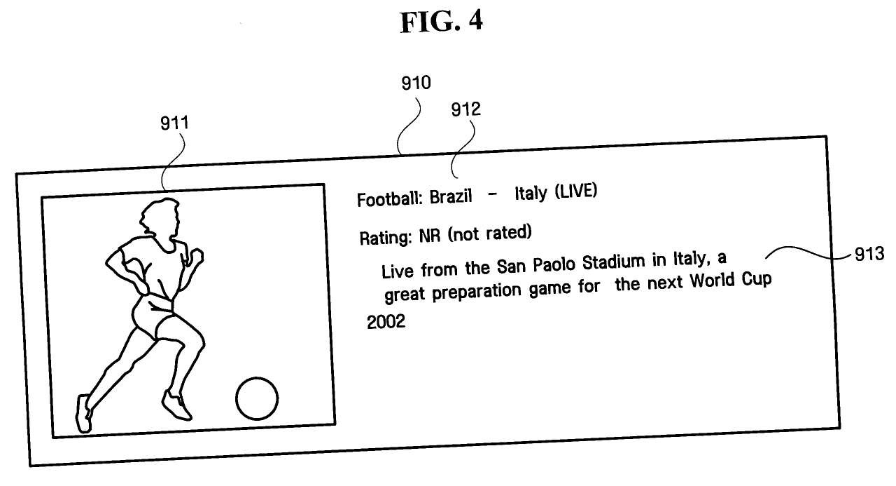

FIG. 4 is a schematic representation of an example of the graphic user interface displayed by the control unit 500 of FIG. 3, i.e., a graphic user interface 910. Referring to FIG. 4, the graphic user interface 910 may display program guide information which consists of still shot information 911, program title information 912, and program content summary 913.

Then, a user can select any of the still shot information 911, the program title information 912, and the program content summary 913 from the graphic user interface 910 by using the user input unit 600.

It is assumed that the user selects the program title information 912, i.e., “Football: Brazil—Italy”, from the graphic user interface 910 of FIG. 4 by pressing a predetermined button provided on the user input unit 600.

A button on the user input unit 600 that must be pressed to choose one of a plurality of items of program guide information may be set in advance or may be changed afterwards by the user.

In addition, the items of the program guide information that must be chosen when the user presses a predetermined button on the user input unit 600 may be set in advance or may be changed afterwards by the user.

If the user chooses an item of program guide information, the control unit 500 outputs the chosen item at a predetermined location on a screen on which a broadcast program that the user currently watches is displayed when program guide information regarding a broadcast program that matches the chosen item is input.

Generally, when a broadcast signal is input, program guide information is also input together with the broadcast signal.

Thus, the control unit 500 may compare program guide information currently being input with previous program guide information and then determine whether the current program guide information contains an item chosen from the previous program guide information by the user.

Thereafter, the control unit 500 may output not only the chosen item but also channel information and start time information regarding a broadcast program that matches the chosen item at a predetermined location on the screen on which the broadcast program that the user currently watches is displayed, so the user can easily time-record or can watch in real time the broadcast program that matches the chosen item even when watching another broadcast program.

The control unit 500 may be set so that a current channel is automatically switched from a channel of the broadcast program that the user currently watches to a channel of the broadcast program that matches the chosen item when the broadcast program that matches the chosen item begins. In this manner, the user can conveniently watch a broadcast program of his or her interest in real time without additional manipulation.

The memory unit 700 includes a first memory 710 which stores program guide information and a second memory 720 which stores an item of the program guide information chosen by the user. Examples of the first and second memories 710 and 720 may include a cache memory, a ROM, a PROM, an EPROM, an EEPROM, a flash memory, an SRAM, and a DRAM. In addition, the first and second memories 710 and 720 may be integrated into a single memory.

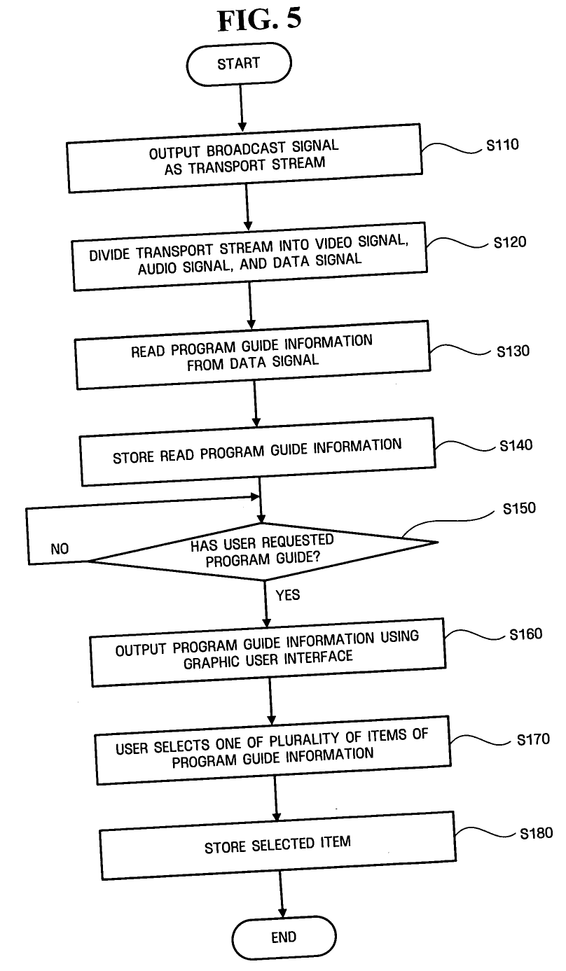

A method of providing a program guide using a digital broadcast receiver according to an exemplary embodiment of the present invention will now be described. FIG. 5 is a flowchart of a method of providing a program guide using the digital broadcast receiver as illustrated in FIG. 3.

Referring to FIG. 5, in operation S110, when the tuner 100 receives a broadcast signal transmitted by a broadcasting station, the modulation unit 200 digitalizes the received broadcast signal and then outputs the digitalized broadcast signal as a transport stream. In operation S120, the dividing unit 300 divides the transport stream output by the modulation unit 200 into a video signal, an audio signal, and a data signal. In operation S130, the reading unit 400 reads program guide information, such as program title information, program content summary, start time information, running time information, rating information, genre information, and still shot information, from the data signal. In operation S140, the control unit 500 stores the read program guide information in the first memory 710.

In operation S150, the control unit 500 determines whether the user has issued a request for program guide information. In operation S160, if it is determined that the user has issued a request for program guide information, the control unit 500 outputs the program guide information stored in the first memory via a predetermined graphic user interface.

An example of the graphic user interface is illustrated in FIG. 4. The user can check the program guide information, such as program title information, program content summary, start time information, running time information, rating information, genre information, and still shot information, via the graphic user interface.

In operation S170, the user identifies a broadcast program or a series of broadcast programs of his or her interest via the graphic user interface and selects one of a plurality of items of the program guide information from the graphic user interface by hitting a predetermined button on the user input unit 600. It is assumed that the item chosen by the user in operation S170 is program title information. The item chosen by the user in operation S170 may be information other than the program title information.

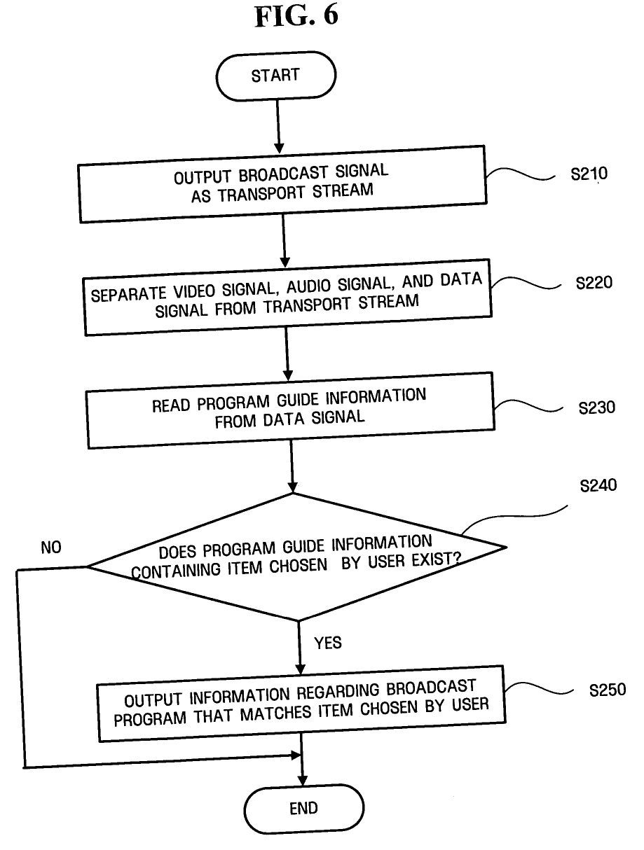

In operation S180, the item chosen by the user is extracted from the first memory 710 and then is stored in the second memory 720. FIG. 6 is a flowchart of a method of providing program guide information that specifies a broadcast program that matches an item chosen by a user by using the digital broadcast receiver illustrated in FIG. 3 when the program guide information is input to the broadcast receiver illustrated in FIG. 3.

Referring to FIG. 6, in operation S210, when the tuner 100 receives a broadcast signal transmitted by a broadcasting station, the modulation unit 200 digitalizes the broadcast signal received by the tuner 100 and outputs the digitalized broadcast signal as a transport stream. In operation S220, the dividing unit 300 divides the transport stream output by the modulation unit 200 into a video signal, an audio signal, and a data signal. In operation S230, the reading unit 400 reads program guide information, such as program title information, program content summary, start time information, running time information, rating information, genre information, and still shot information, from the data signal.

In operation S240, the control unit 500 determines whether program guide information containing the same item as an item chosen from the read program guide information and stored in the second memory 720 exists. For example, assuming that the item stored in the second memory 720 is the program title information 911 of FIG. 4, i.e., “Football: Brazil—Italy”, the control unit 500 may determine whether program guide information containing the same item as “Football: Brazil—Italy” exists.

In operation S250, if it is determined in operation S240 that program guide information containing the same item as the item stored in the second memory 720 exists, the control unit 500 outputs the title, channel information, and start time information of a broadcast program specified by the program guide information that matches the item stored in the second memory 720 via the video output unit 830.

If a video signal is currently output via the video output unit 830, the control unit 500 may lay the title, the channel information, and the start information of the broadcast program that matches the item stored in the second memory 720 over the video signal currently being output via the video signal.

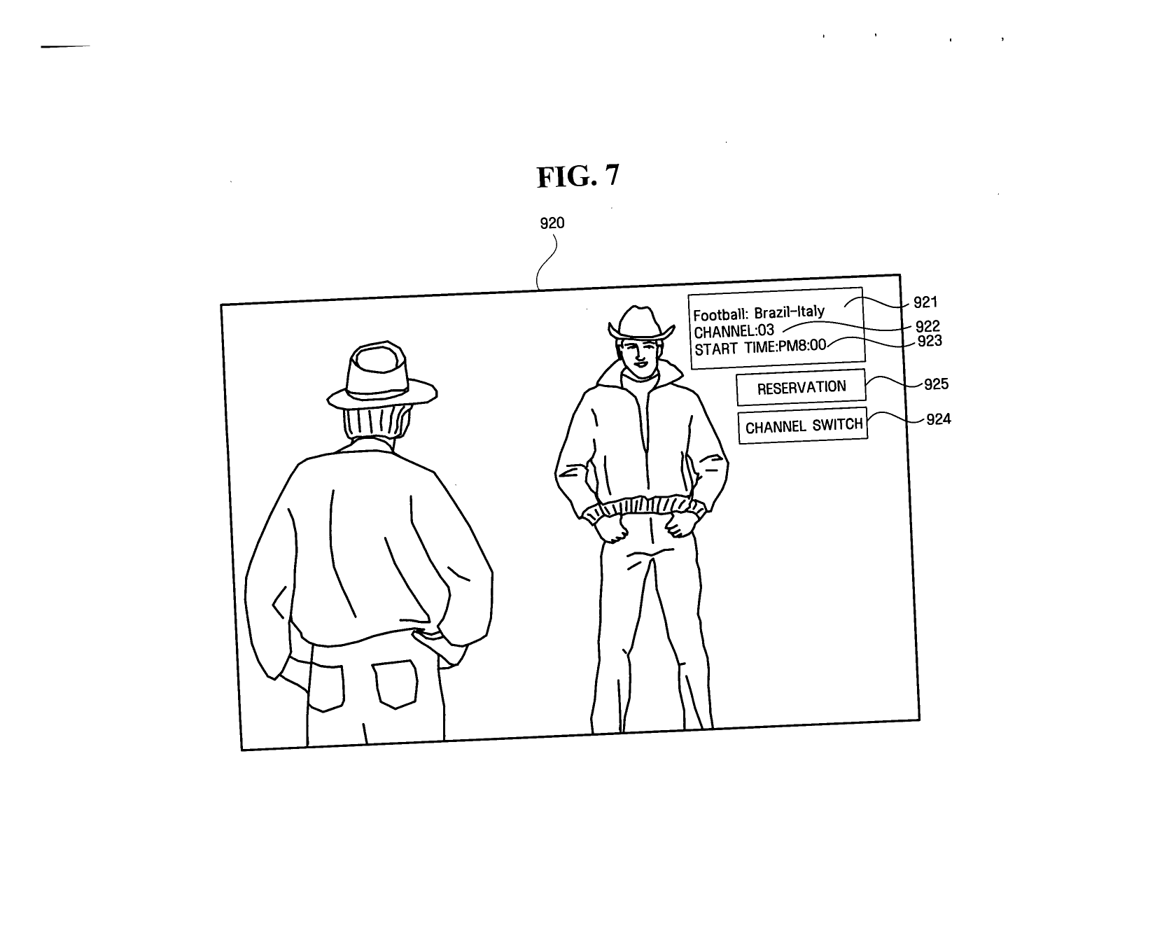

For example, title information 921, channel information 922, and start time information 923 of the broadcast program that matches the item stored in the second memory 720 may be laid over a predetermined location on a screen 920 on which a broadcast program that the user currently watches is displayed, as illustrated in FIG. 7.

Therefore, the user can easily identify channel information and start time information of a broadcast program of his or her interest without additional manipulation.

In addition, the control unit 500 may output a ‘channel switch’ button 924 and a ‘reservation’ button 925 at a predetermined location on the screen 920, so the user can easily watch in real time or time-record a broadcast program of his or her interest while watching another broadcast program.

The ‘channel switch’ button 924 enables a current channel to be automatically switched from a channel of a broadcast program that the user currently watches to a channel of a broadcast program of the user's interest when the broadcast program of the user's interest begins. Thus, the user can conveniently watch the broadcast program of his or her interest without additional manipulation to switch channels.

In addition, the ‘reservation’ button 925 enables the broadcast program of the user's interest to be automatically recorded through reservation when the broadcast program of the user's interest begins. The ‘channel switch’ button 924 and the ‘reservation’ button 925 may be output together or may be selectively output.

Alternatively, the ‘channel switch’ button 924 and the ‘reservation’ button 925 may not be output when the user sets a channel switch function or a reservation function in advance as a default setting, in which case, the control unit 500 performs the channel switch function or the reservation function even when the user does not select the channel switch function or the reservation function.

The digital broadcast receiver according to the present invention and the method of providing a program guide using the digital broadcast receiver according to the present invention have the following advantages.

First, when a user wishes to watch a broadcast program more than one time or wishes to watch a series of broadcast programs, he or she can conveniently watch the broadcast program(s) without the need to check out start time information of the broadcast program(s).

Second, the user can conveniently watch in real time or time-record a broadcast program of his or her interest even while watching another broadcast program.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A digital broadcast receiver, comprising:
a reading unit which reads program guide information from a data signal contained in a broadcast signal; and
a control unit which extracts an item chosen by a user from the read program guide information and outputs the extracted item when a broadcast program that matches the extracted item is broadcasted.

2. The digital broadcast receiver of claim 1, further comprising:
a user input unit into which a value chosen by the user is input; and
a memory unit which stores the read program guide information and the extracted item.

3. The digital broadcast receiver of claim 2, wherein the control unit extracts a predetermined text chosen by the user from the program guide information.

4. The digital broadcast receiver of claim 3, wherein, if program guide information containing the extracted item is received again, the control unit outputs at least one of channel information and start time information of a broadcast program specified by the program guide information at a predetermined location on a screen.

5. The digital broadcast receiver of claim 3, wherein, if program guide information containing the extracted item is received again, the control unit automatically switches a current channel to a channel of a broadcast program specified by the program guide information when the broadcast program specified by the program guide information begins.

6. A method of providing a program guide using a digital broadcast receiver, comprising:
reading program guide information from a data signal contained in a broadcast signal;
extracting an item chosen by a user from the read program guide information; and
outputting the extracted item when a broadcast program that matches the extracted item is broadcasted.

7. The method of claim 6, wherein the extracting comprises outputting the read program guide information using a predetermined graphic user interface.

8. The method of claim 7, wherein the extracting further comprises storing the extracted item.

9. The method of claim 8, wherein the outputting comprises outputting the stored item and channel information and start time information of a broadcast program that matches the stored item.

10. The method of claim 9 further comprising automatically switching a current channel to a channel of a broadcast program corresponding to the output channel information and the output start time information.

11. A method, comprising:
storing information related to a program that interests a user; and
displaying at least a part of the information related to the program that interests the user upon detecting a start time of the program that interests the user.

12. The method of claim 11, wherein the displaying of at least a part of the information related to the program that interests the user upon detecting a start time of the program that interests the user comprises:
comparing the stored information with a second instance of the information related to the program that interests the user.

13. The method of claim 12, wherein the comparing of the stored information with a second instance of the information related to the program that interests the user comprises:
comparing the stored information with information received with a broadcast signal.

14. The method of claim 11, further comprising:
receiving an indication of the program that interests the user.

15. A method, comprising:
storing information related to a program that interests a user; and
identifying a start-time of the program that interests the user by comparing the stored information with received information.

16. The method of claim 15, wherein the identifying a start-time of the program that interests the user by comparing the stored information with received information comprises:
comparing the stored information with information received in a broadcast signal.
